(19) United States
(12) Patent Application Publication
(10) Pub. No.: US 2002/0189987 A1
(43) Pub. Date: Dec. 19, 2002

(54) Desalination system of sea water for ship

(76) Inventor: Patrick Wagner, Antibes (FR)

Correspondence Address: James C Lydon, 100 Daingerfield Road Suite 100, Alexandria, VA, 22314, US

(21) Appl. No.: 10/168,130

(22) PCT Filed: Dec. 19, 2000
(86) PCT No.: PCT/FR00/03598

(30) Foreign Application Priority Data
Dec. 20, 1999 (FR) 99/16088

(51) Int. Cl. B01D 35/02

(52) U.S. Cl. 210/143; 210/96.2; 210/170; 210/321.65; 210/242.1

(57) ABSTRACT

The invention concerns a seawater desalination system comprising a reverse osmosis cell (12) containing a semi-permeable membrane for performing desalination of the water by passing seawater under pressure through the membrane, a pump (20) for forcing the pressurized seawater through said membrane and a mechanism driving the pump shaft comprising a direct current motor (22) and an alternating current motor (24), the two motors being mounted in position for driving the pump shaft with a belt, and also comprising clutch means for preventing one of the motors from being driven in rotation while the other motor is activated and drives the pump shaft in rotation.

### TECHNICAL FIELD

The present invention concerns seawater desalination systems onboard ships, particularly sailboats, and designed to provide potable water to the occupants of ships while at sea, and specifically concerns a seawater desalination system operating with both AC as well as DC current.

### BACKGROUND ART

Sailboats of a certain size are increasingly equipped with seawater desalination systems which supply potable water to ship occupants when at sea for a certain time. Such a system described in the article entitled “Reverse-Osmosis desalinisation for shipboard potable water” by Adamson & Pizzino, published in the “Naval Engineers Journal, vol. 91, April 1979, generally consists of a reverse-osmosis membrane through which seawater is forced under pressure such that only potable water passes through the membrane while the majority of the mineral salts is retained by the membrane.

A pump is required to force seawater under considerable pressure (up to 65 bar) through the membrane used to perform reverse osmosis. A pump drive mechanism is thus required. The drive mechanism is generally a direct current motor powered by the shipboard battery which is recharged by a dynamo driven in rotation by a wind-powered generator. It goes without saying that such a battery, while sufficient to power the ship's lighting system, rapidly discharges when coupled to a motor. In order to mitigate possible battery deficiency, sailboats are equipped with a motor-generator set which supplies alternating current. When the battery is discharged or when there is not enough wind to operate the wind-powered generator or when the ship is at berth, it is thus common to start the motor-generator set and to use a charger to convert the 220 volts AC into 12 or 24 volts DC to power the motor used for seawater desalination purposes. It is clear that such a system consumes a considerable amount of energy by transforming alternating current into direct current and is not at all practical to implement.

### DISCLOSURE OF THE INVENTION

Consequently, the purpose of the invention is to provide a seawater desalination system whose pump driving mechanism is either a direct current motor or an alternating current motor, the switch from one to the other taking place automatically without human intervention.

The purpose of the invention is thus a seawater desalination system featuring a reverse osmosis cell (12) containing a semi-permeable membrane for performing desalination of seawater by passing seawater under pressure through the membrane, a pump for forcing the pressurized seawater through the membrane and a mechanism driving the pump shaft comprising a direct current motor powered by direct current and an alternating current motor powered by alternating current. The motors are mounted in pump shaft driving position by a belt which drives a pulley at each end of the shaft, each belt linking the drive shaft of the corresponding motor to the pump shaft such that each of the motors drive the pump shaft in rotation when it is activated. The drive mechanism includes clutching means resulting from the freewheel configuration of each of the pulleys on the pump shaft, so that the pulley corresponding to one of the motors freewheels while the other motor is activated to drive the pump shaft.

### BRIEF DESCRIPTION OF THE DRAWINGS

The purposes, objects and characteristics of the invention will become more apparent from the following description when taken in conjunction with the accompanying drawings in which:

FIG. 1 schematically represents a boat in which a seawater desalination system according to the invention is installed, and

FIG. 2 schematically represents an embodiment of the seawater desalination system according to the invention showing the direct current motor as well as the alternating current motor used to drive the pump.

### DETAILED DESCRIPTION OF THE INVENTION

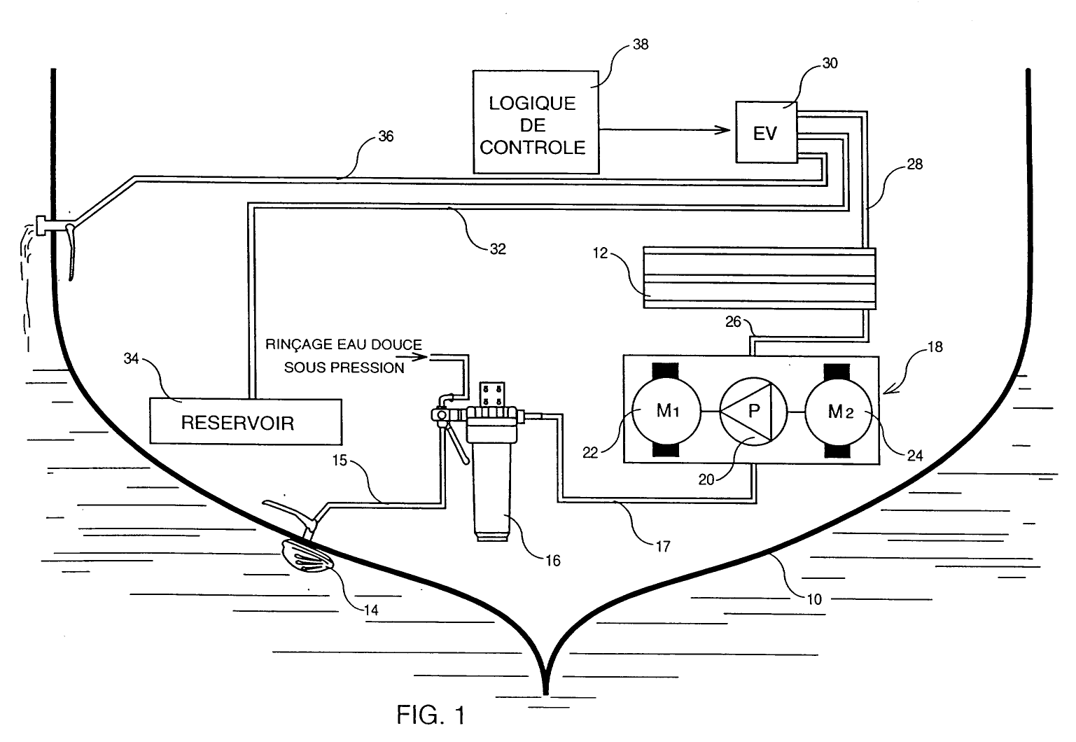

The desalination system according to the invention is schematically represented inside the hull of the ship 10 in FIG. 1. Desalination takes place owing to a reverse osmosis cell 12 containing a semi-permeable membrane. Seawater is pumped at a pressure of at least 26 bar and up to 65 bar in the cell 12. The semi-permeable membrane allows water to pass through it but mineral salts are retained. This enables fresh water to be obtained with a salinity content below the legal limit. The seawater to be desalinized is drawn in by the pump, through the intake valve 14. This water first passes through a filter 16 which retains particles which are larger than a specified size. It should be noted that the filter 16 must be cleaned and the seawater intake line 15 rinsed periodically.

The filtered seawater is then transported via a pipe 17 to a pumping unit 18 comprising a pump 20, a direct current motor (M1) 22 and an alternating current motor (M2) 24, one of the two motors driving the shaft of the pump 20 as explained below.

When operating, the pump 20 forces seawater through the pipe 26 against the membrane in the reverse-osmosis cell 12. The fresh water collected at the outlet of the cell 12 via the pipe 28 is directed to an electrovalve 30 which routes it via pipe 32 to a fresh water tank 34 when its salinity level corresponds to a certain level of potability, or discharges it outside the boat by a pipe 36 when the potability quality of the water collected is not sufficient.

The routing of water to either of pipes 32 and 36 by the solenoid valve 30 is controlled by control logic which may be a simple CMOS electronic board. The control signal sent by the control logic 38 takes into account the water salinity information provided by the salinity detector(not shown) provided with two electrodes which measure the salinity by resistivity. Two thresholds are measured: a potability threshold and a non-potability threshold corresponding to the legal limit. When the salinity level is below the potability threshold, the water is considered potable and is thus sent by pipe 32 to the tank 34. When the salinity level increases and exceeds the non-potability threshold, the water is then discharged overboard via pipe 36 when the non-potability threshold is attained. If the salinity level then drops, the water continues to be discharged overboard until the salinity level falls below the potability threshold. At this time, since the water is considered sufficiently potable, it is once again directed into the tank 34 via the pipe 32. This three-status control procedure of the electrovalve 30 ensures quality production and high reliability of the command.

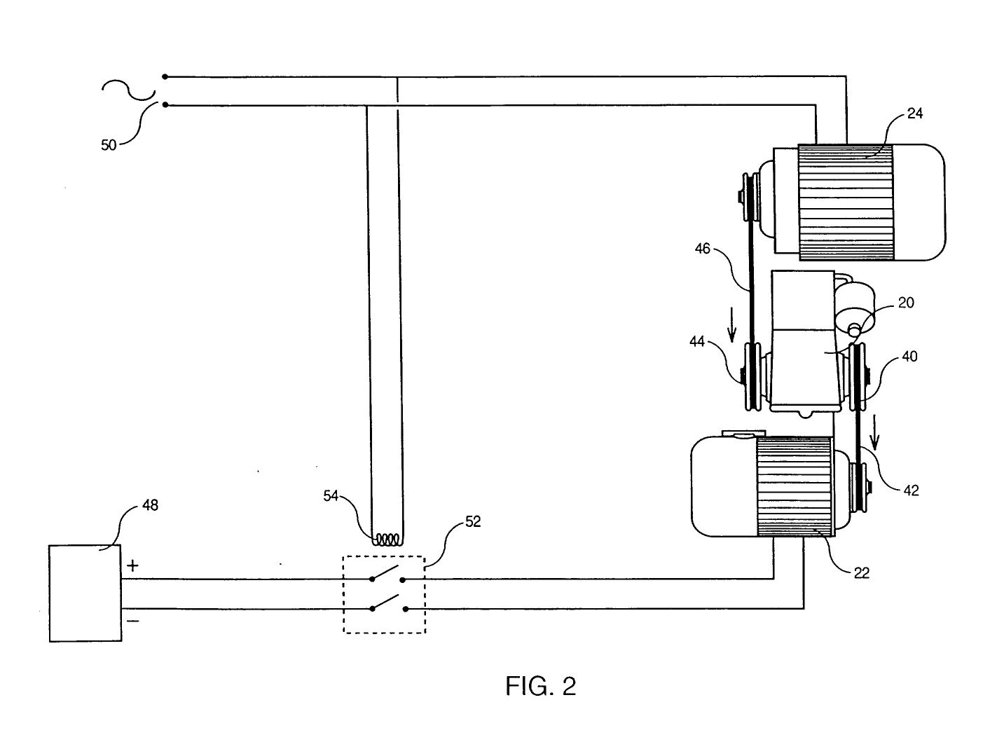

The pump unit 18 according to the invention shown in FIG. 2 features a pump 20 the shaft of which has a pulley mounted on each end.

The pulley 40 is connected to the drive shaft of the direct current motor 22 by a belt 42, and the pulley 44 is connected to the drive shaft of the alternating current 24 by the belt 46. Both pulleys 40 and 44 freewheel on the pump shaft. When only one of the motors 22 or 24 drives the corresponding pulley in rotation by the associated belt in the direction of the arrow, the frictional force exerted by the pulley being less than the frictional force exerted by the other motor which is off, the corresponding pulley freewheels and the motor which is off does not turn. In this manner, by assuming that the direct current motor 22 is activated, it drives the pulley 40 in rotation by means of the belt 42 and thus drives the shaft of the pump 20 in rotation. However, as the frictional force exerted by the shaft of the alternating current motor 24 is greater than the frictional force exerted by the pulley, the pulley 44 freewheels, the belt 46 remains immobile and does not drive the motor 24. In the same manner, when the alternating current motor 24 is activated, the pulley 40 and the belt 42 remain immobile and do not drive the motor 22.

A significant characteristic of the invention is to power only one of the motors in case the system is provided with a 12 or 24 volt battery power supply 48 and 220 volt 50 Hz electrical power supplied by a motor-generator set. To accomplish this, the 220 volt power source takes precedence as shown in FIG. 2 which represents a first embodiment of the invention. By assuming that the direct current motor 22 is powered by the single battery 48, the switch 52 is closed. When the motor-generator set starts, the electromagnetic relay 54 is activated and the switch 52 opens, thus switching the direct current motor 22 off. In this manner, only the alternating current motor 24 is powered.

It should be noted that, in a second embodiment, switching from direct current to alternating current is carried out automatically in the control logic. In addition, the control logic manages the timing such as a 30-second delay before potable water can be collected in the tank once the system has been switched on.

1. A seawater desalination system featuring a reverse osmosis cell (12) containing a semi-permeable membrane for performing desalination of the seawater by passing seawater under pressure through said membrane, a pump (20) for forcing pressurized seawater through said membrane and a mechanism driving said pump shaft comprising a direct current motor (22) powered by direct current (48) and an alternating current motor (24) powered by alternating current (50),
said system being characterized in that:
said motors are mounted in position to drive the shaft of said pump by a belt (42 or 46) which drives a pulley (40 or 44) at each end of said shaft, each of said belts linking the drive shaft of the corresponding motor to the shaft of said pump such that each of said motors drives the shaft of said pump in rotation when it is activated, and
said drive mechanism includes clutching means resulting from the freewheel configuration of each of said pulleys on the shaft of said pump (20), such that the pulley corresponding to one of said motors freewheels while the other motor is activated to drive the shaft of said pump.

2. The system according to claim 1, also including selection means for activating only said alternating current motor (24) and thus driving the shaft of said pump (20) when both motors are supplied with electrical power.

3. The system according to claim 2, in which said selection means include an electromagnetic relay (54) supplied by said alternating current (50) when it is connected and a switch (52) in the power supply circuit of said direct current motor (22), said switch being normally closed and moving to open position when said electromagnetic relay is powered by said alternating current so that said direct current motor is no longer activated when said alternating current is connected.

4. The system according to claim 2, in which said selection means are comprised by control logic (38) such as an electric board or CMOS technology.

5. The system according to any one of claims 1 to 4, also including a tank (34) into which is directed the desalinated water after passing through said membrane (12).

6. The system according to claim 5, also including an electrovalve (30) to send desalinized water into said tank when the quality of said water is sufficient and to expel the desalinized water when its quality is insufficient.

7. The system according to claim 6, also featuring a water salinity analysis method to supply a potability threshold of the desalinized water, said non-potability threshold corresponding to a salinity which is higher than said potability threshold, said water being expelled only when its salinity exceeds the non-potability threshold, and being stored in said tank (34) after having been rejected for insufficient quality only when its salinity has returned below said potability threshold.

8. The system according to any of the previous claims, installed on board a boat such as a sailboat.
